(19) United States
(12) Patent Application Publication
(10) Pub. No.: US 2026/0088633 A1
(43) Pub. Date: Mar. 26, 2026

(54) GENERATOR FOR PRODUCTION OF ELECTRIC ENERGY

(71) Applicants: Vitaly Gennadievich PERETYACHENKO, Bucharest (RO); Oleg Konstantinovich KRISHEVICH, St. Petersburg (RU)

(72) Inventors: Oleg Urievich GERMAN, Saransk (RU); Vitaly Gennadievich PERETYACHENKO, Bucharest (RO); Oleg Konstantinovich KRISHEVICH, St. Petersburg (RU); Oleg Konstantinovich SHTADELMAN, Moscow (RU)

(21) Appl. No.: 19/032,987

(22) PCT Filed: Apr. 5, 2023
(86) PCT No.: PCT/IB2023/053488

§ 371 Date: Nov. 28, 2025

(51) Int. Cl. H02J 7/34

(52) U.S. Cl. CPC H02J 7/345; H02J 7/50

(57) ABSTRACT

Invention relates to electric power engineering and power supply systems of different sectors of national economy: industrial, agricultural, defence, transport and amenity facilities. The invention improves generator operation reliability and consistency to produce electric energy. A generator for production of electric energy is designed with a possibility of connection to the starting electric energy source and disconnection from it, which output is connected to the energy storage capacitor and the discharger unit series-connected to the primary winding of the transformer, which secondary high voltage winding together with the parallel-connected capacitor form a resonant circuit establishing the positive feedback with the energy storage capacitor of the discharger, and the transformer tertiary winding feeds the load via a rectifier, wherein the discharger unit is executed as several dischargers connected in parallel, characterized by different values of breakdown voltage and by shifted relative to each other, but overlapping frequency spectra.

### FIELD OF THE INVENTION

The present invention relates to electric power engineering and may be used in power supply systems of different sectors of national economy: industrial, agricultural, defence, transport and amenity facilities.

### BACKGROUND OF THE RELATED ART

Conventional art describes a device for production of electric energy according to RU 2261521 (published on Sep. 27, 2005) consisting of an electric energy source feeding a current pulse generator which output is connected to an energy storage capacitor and a discharger connected in series to primary winding of a transformer, which secondary high-voltage winding and a parallel connected capacitor form a resonant circuit, which with the use of a diode establishes a positive feedback with the storage capacitor of the discharger, and the transformer tertiary winding feeds the load via a rectifier bridge.

A disadvantage of the said electric energy generator is that in the course of time, because of oxide formation and partial mechanical disintegration of the discharger electrodes, a change in discharge frequency of the discharger is observed which initiates oscillations in the transformer tertiary winding circuit. A process of the discharger electrodes disintegration is due to presence of plasma between the electrodes causing electric erosion disintegration of the electrode metal which inevitably results in an increase of distance between them relative to the initial distance and a shift in frequency spectrum of the discharger oscilations relative to the resonance frequency of the transformer primary winding circuit. Therefore, spectral density of the discharge current at resonance frequency of the transformer primary winding circuit is decreasing which may lead to the device service outage. The shift in frequency spectrum of the discharger may also be determined by a change in air conditions in the discharge gap. It is common knowledge that the discharge repetition frequency increases as the air humidity increases (publication by Pengfei Xu, Bo Zhang, Shuiming Chen, and Jinliang He, “Influence of humidity on the characteristics of positive corona discharge in air”, Physics of Plasmas 23, 063511 (2016); https://doi.org/10.1063/1.4953890).

### SUMMARY OF THE INVENTION

The technical result of the claimed invention lies in improvement of the generator operation reliability and consistency to produce electric energy.

The technical result is achieved in the generator for production of electric energy, designed with a possibility of connection to the starting electric energy source and disconnection from it, which output is connected to the energy storage capacitor and the discharger unit series-connected to the primary winding of the transformer, which secondary high-voltage winding together with the parallel-connected capacitor form the resonant circuit establishing the positive feedback with the storage capacitor of the discharger, and the transformer tertiary winding feeds the load via a rectifier bridge, wherein the discharger unit is executed as several dischargers connected in parallel, characterized by different values of breakdown voltage and by shifted relative to each other, but overlapping frequency spectrums.

When using several dischargers connected in parallel, characterized by different values of breakdown voltage and by shifted, relative to each other, but overlapping frequency spectrums, spectral densities of the dischargers at the resonance frequency of the transformer primary winding circuit are added and, at a shift in frequency spectrum of the discharger oscilations relative to the resonance frequency of the transformer primary winding circuit (for example, due to increase of distance between the electrodes in the course of time or change in air conditions in the discharge gap) ensure an increase in the cumulative spectral density due to the contribution of the spectral density of another or other dischargers which spectrums are overlapping with the first discharger spectrum. Thus, the technical result is achieved in terms of improved reliability and stability of operation of the device for generating electric power in case of a shift in frequency spectrum of the discharger due to a change of distance between the electrodes or air conditions in the discharge gap.

In a preferred embodiment dischargers of the discharger unit are with shifts in frequency spectrums ensuring a close-to-uniform cumulative spectral density in the range of the discharger frequencies.

In a preferred embodiment the transformer primary winding circuit is in the form of a slab coil with a resonance frequency of 2.45 MHz.

In a preferred embodiment the rectifier is in the form of a diode bridge.

In a preferred embodiment the dischargers are with shifts in frequency spectrum of 10-20 kHz relative to each other.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 shows a block flow diagram illustrating the invention.

### DETAILED DESCRIPTION OF EMBODIMENTS OF THE INVENTION

Reference will now be made in detail to the preferred embodiments of the present invention, examples of which are illustrated in the accompanying drawings.

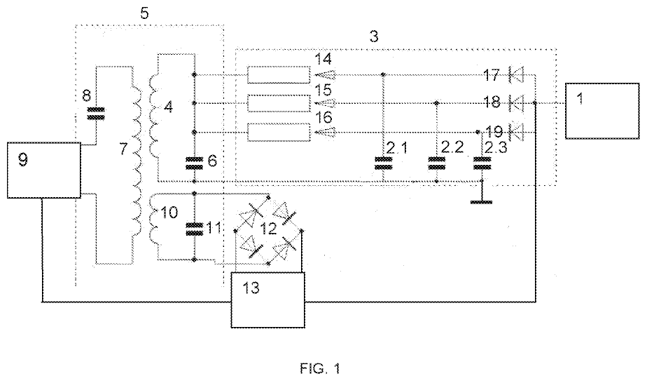

The principle of operation of the generator for production of electric energy is explained in FIG. 1 showing its block flow diagram.

The generator for production of electric energy is implemented in a generator connected to starting electric energy source 1, whose output is connected to energy storage capacitors 2 and discharger unit 3 series-connected to a primary winding 4 of a transformer 5, whose secondary high-voltage winding 6 together with parallel-connected capacitor 7 form a resonant circuit, with a positive feedback unit 8 of the resonant circuit with the energy storage capacitor 2 of the discharger 3, and tertiary winding 9 of the transformer 5 via a rectifier 10, executed according to diode bridge scheme, feeds load 11, wherein the discharger unit 3 is implemented as three parallel dischargers 12, 13, 14, all connected in series between source 1 and winding 4, characterized by different values of breakdown voltage and shifted relative to each other by 10 kHz, but overlapping frequency spectra.

The generator for production of electric energy operates as follows.

Starting electric energy source 1 serves as a starting generator for production of electric energy, and is used only at the initial moment, and includes electric energy source, with electric mains, accumulator or battery may be used for that purpose, a converter of low voltage into high voltage and diode, through which voltage is applied to the energy storage capacitors 2, and through the discharger unit 3 to the primary winding 4 of the transformer 5. Electric charge accumulated by the capacitor 2 from the starting electric energy source 1 is applied via the discharger unit 3 to the primary winding 4 of the transformer 5 such that a magnetic field with high spatial voltage gradient is established in the surrounding space. At that, streamers of corona discharge are formed in the discharger unit 3 due to ionization by air molecule collision and generation of avalanche electron flows near anode target tip due to a highly non-uniform field.

Ionized air molecules, being much heavier, fail to reach the cathode in the time of discharge pulse and form a bulk charge near the cathode, which interrupts the corona discharge pulse and slowly dissipates in the surrounding space or recombines with electrons flowing into the discharge gap form the cathode. Photoionization of air molecules, arising from ultraviolet radiation of the streamers, is also of great importance for the avalanche development. Thus, pulses of current are generated in the discharger unit 3, where the current exceeds the current of electrons initiating the corona discharge.

On completion of the discharge in the discharger unit 3 the primary winding magnetic field is transmitted by induction to the secondary winding 6 of the transformer 5, which together with the capacitor 7 form a resonant circuit. Voltage from the secondary winding 6 of the transformer 5 is transferred via a positive feedback unit 8 to the energy storage capacitors 2, thus implementing the positive feedback. After a lapse of time, required for the generator oscillation, starting electric energy source 1 is switched off.

Accumulated by energy storage capacitor 2 electric charge, in a lapse of time which is characteristic of each discharger of the discharger unit 3, is fed, when they are discharged, to the primary winding 4 of the transformer 5, around which pulsed magnetic field with increased energy is generated due to formation of streamers of corona discharge. Further, due to induction it is fed to the secondary winding 6 of the transformer 5, forming a resonant circuit together with the capacitor 7. The obtained energy excess is removed by the tertiary winding 9 of the transformer 5 and via the rectifier 10, executed according to diode bridge scheme, feeds the load 11.

Let a spectral density maximum of frequency spectrum of discharger 12 originally coincide with a resonance frequency of the circuit formed by the primary winding 4 of the transformer 5, wherein maxima of spectral density of the dischargers 13 and 14 are positioned on both sides of the spectral density maximum of frequency spectrum of the discharger 12. Then, in case of a shift of the spectral density maximum of frequency spectrum of discharger 12, for example, in the direction of the spectral density maximum of frequency spectrum of discharger 13, which shift is due to a change in distance between electrodes of the discharger 3 or air condition in the discharge gap, the spectral density of the discharger 12 shall decrease, however, the spectral density maximum of frequency spectrum of the discharger 13 shall increase at that. In case of a shift of the spectral density maximum of frequency spectrum of the discharger 12 in the direction of the spectral density maximum of the frequency spectrum of the discharger 14, the spectral density of the discharger 12 shall decrease, however, the spectral density of frequency spectrum of the discharger 14 shall increase at that, compensating that decrease in the spectral density of frequency spectrum of discharger 12. That is, use of several dischargers 12, 13, 14, executed with a shift of the spectral density maximum of frequency spectrum relative to each other, when their spectrums overlap, shall ensure higher reliability and consistency of operation of the generator for production of electric energy by compensating the spectral density decrease of the resonator 12 at the resonance frequency of the primary winding circuit via increase of the spectral density of one of the resonators 13, 14 of the resonator 3.

Thus, when using several dischargers connected in parallel, characterized by different values of breakdown voltage and by shifted, relative to each other, but overlapping frequency spectrums, spectral densities of the dischargers at the resonance frequency of the transformer primary winding circuit are added and, at a shift in frequency spectrum of the first discharger oscilations relative to the resonance frequency of the transformer primary winding circuit (for example, due to increase of distance between the electrodes in the course of time or change in air conditions in the discharge gap) ensure an increase in the cumulative spectral density due to the contribution of the spectral density of another or other dischargers, which spectrums are overlapping with the first discharger spectrum. Therefore, in the described generator for production of electric energy the attainment of the technical result is ensured in the form of higher reliability and consistency of operation of the generator for production of electric energy.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

1. (canceled)

2. (canceled)

3. (canceled)

4. (canceled)

5. (canceled)

6. A generator system for production of electric energy, comprising:
a generator coupled to a starting electric energy source,
wherein an output of the starting electric energy source is connected to an energy storage capacitor; and
discharger unit that is series-connected to a primary winding of the transformer, such that a secondary high-voltage winding of the transformer forms a resonant circuit together with a parallel connected capacitor,
wherein the resonator establishes the positive feedback with the energy storage capacitor of the discharger, and the transformer tertiary winding feeds the load via a rectifier,
wherein the discharger unit includes multiple dischargers connected in parallel, with different values of breakdown voltage and having overlapping frequency spectra that are shifted relative to each other.

7. The generator of claim 6, wherein the dischargers have the overlapping frequency spectra ensuring a close-to-uniform cumulative spectral density in the frequency range of the dischargers.

8. The generator of claim 6, wherein the primary winding of the transformer is a slab coil with a resonance frequency of 2.45 MHz.

9. The generator of claim 6, wherein the rectifier is a diode bridge.

10. The generator of claim 6, wherein the multiple dischargers have shifts in their frequency spectra of 10-20 kHz relative to each other.
